(19) United States
(12) Patent Application Publication
(10) Pub. No.: US 2013/0192008 A1
(43) Pub. Date: Aug. 1, 2013

(54) METHOD FOR ATTACHING AND REMOVING A TRAILER RAMP

(71) Applicant: Duane R. Smith, Burlington, KS (US)

(72) Inventor: Duane R. Smith, Burlington, KS (US)

(21) Appl. No.: 13/774,969

(22) Filed: Feb. 22, 2013

Related U.S. Application Data
(62) Division of application No. 12/487,993, filed on Jun. 19, 2009, now abandoned.

(51) Int. Cl. B60P 1/43

(52) U.S. Cl. CPC B60P 1/43
USPC 14/69.5

(57) ABSTRACT

A method is disclosed for connecting a trailer ramp to a trailer. The method includes providing a trailer, wherein either two housing members or two pins are affixed to the trailer. The method further includes providing a ramp, wherein the other of the two housing members or the two pins are affixed to the ramp. Each of the housing members comprises a hollowed-out cylindrical stock having a tubular portion and a semi-tubular portion and the semi-tubular portion has a cutaway that forms a substantially half-tubular surface. A single person then initially engages the semi-tubular portion of the first housing member with the first pin, initially engages the semi-tubular portion of the second housing member with the second pin, and finally slides the ramp along the length of the pins to fully engage the pins into the tubular portions of the housing members.

### CROSS-REFERENCES TO RELATED APPLICATIONS

This is a divisional application of and claims priority to U.S. patent application Ser. No. 12/487,993 entitled “Trailer Ramp Assistant” and filed on Jun. 19, 2009 for Duane R. Smith, which is incorporated herein by reference.

### FIELD

This invention relates to trailer gate ramps and more particularly relates to a connection assembly that enables a gate ramp to be easily installed or removed from a trailer by a single person.

### BACKGROUND

Traditional trailers may include a gate ramp that is connected to the trailer bed in such a manner that it functions as a gate when it is raised vertically and as a ramp when it is lowered. However, when traveling at highway speeds the gate ramp creates considerable wind resistance, which is detrimental to the fuel efficiency of the towing vehicle. Removing the gate ramp from the rear of said trailer can eliminate the problem associated with wind resistance, and placing said gate ramp along a side of said trailer or upon the trailer bed.

As a preliminary note, it should be stated that there is an ample amount of prior art that deals with trailers, trailer ramps, and trailer accessories. However, as will be discussed immediately below, no prior art discloses a connection assembly that enables a trailer ramp or gate ramp to be either installed or removed from a trailer by a single person.

Some commercial trailers allow for the removal and attachment of the gate ramp by having two connection units that do not have a cutaway section on the connections. To reattach said gate ramp requires the use of two people, on either side, to lift the gate ramp and position the two connection units in perfect alignment with their pins and then pull the ramp gate to the side to cause the two pins to be inserted in their respective connection simultaneously.

While the above described devices fulfill their respective and particular objects and requirements, they do not describe a connection assembly for a gate or ramp that enables a gate or ramp to easily connect to or disconnect from a trailer by a single person. In this regard, the trailer ramp assistant described and claimed in the present disclosure departs from the conventional concepts and designs of the prior art.

### SUMMARY

From the foregoing discussion, it should be apparent that a need exists for an apparatus and method that provides for a single person to attach and remove a trailer ramp. The subject matter of the present application has been developed in response to the present state of the art, and in particular, in response to the problems and needs in the art that have not yet been fully solved by currently available trailer ramp connection mechanisms. Accordingly, the present disclosure has been developed to provide an apparatus and method for attaching and removing a trailer ramp that overcome many or all of the above-discussed shortcomings in the art.

The trailer ramp mechanism of the present disclosure includes a connection assembly including a plurality of connection units, each connection unit comprising a pin and corresponding housing member, wherein each housing member has a cutaway to enable sliding upon said pins for connection or removal of a gate or ramp from a trailer. The pins are permanently affixed to the trailer whereas the housing members are affixed to a gate ramp. The housing members and pins enable the gate or ramp to be removed from the trailer and easily reattached by a single person.

An object of this application is to provide a connection assembly for use with gates or ramps of trailers that enables the gate or ramp of a trailer to be easily attached for removed from the trailer by a single person. These together with additional objects, features, and advantages of the trailer ramp connection assembly will be readily apparent to those of ordinary skill in the art upon reading the following detailed description of present preferred, but nonetheless illustrative, embodiments of the trailer ramp connection assembly when taken in conjunction with the accompanying drawings.

The present disclosure relates to a method for connecting a trailer ramp to a trailer. The method includes providing a trailer, wherein either a first and a second housing member or a first and a second pin are affixed to the trailer. The method further includes providing a ramp, wherein the other of the first and the second housing member or the first and the second pin are affixed to the ramp. Each of the housing members comprises a hollowed-out cylindrical stock having a tubular portion and a semi-tubular portion and the semi-tubular portion has a cutaway that forms a substantially half-tubular surface. The method also includes a single person initially engaging the semi-tubular portion of the first housing member with the first pin, initially engaging the semi-tubular portion of the second housing member with the second pin, and finally sliding the ramp along the length of the pins to fully engage the first and second pins into the tubular portions of the first and second housing members.

Each pin may include a cylindrical stock that has a narrow portion and a wide portion, the narrow portion having a diameter less than the inside diameter of the housing members and the wide portion having a diameter greater than the inside diameter of the housing members. In one embodiment, the housing members may be affixed to the ramp and the pins may be affixed to the trailer. Initially engaging the semi-tubular portion of the first housing member with the first pin may include lifting a first side of the ramp above the height of the first pin and resting the semi-tubular portion of the first housing member on top of the narrow portion of the first pin. Initially engaging the semi-tubular portion of the second housing member with the second pin may include lifting a second side of the ramp above the height of the second pin and resting the semi-tubular portion of the second housing member on top of the narrow portion of the second pin.

The present disclosure also relates to a method for disconnecting a trailer ramp from a trailer. Such a method includes providing a trailer, wherein either a first and a second housing member or a first and a second pin are affixed to the trailer. The method also includes providing a ramp, wherein the other of the first and the second housing member or the first and the second pin are affixed to the ramp and the ramp and the trailer are connected together. Each of the housing members includes a hollowed-out cylindrical stock having a tubular portion and a semi-tubular portion, the semi-tubular portion having a cutaway that forms a substantially half-tubular surface.

The method further includes a single person sliding the ramp along the length of the pins to remove the first and second pins from the tubular portion of the first and second housing members, disengaging the semi-tubular portion of the first housing member from the first pin, and disengaging the semi-tubular portion of the second housing member from the second pin.

Reference throughout this specification to features, advantages, or similar language does not imply that all of the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the subject matter of the present application will be described and explained with additional specificity and detail through the use of the accompanying drawings, in which:

FIG. 1 is a perspective view illustrating one embodiment of the trailer ramp connection assembly, including two connection units, wherein the gate ramp is disconnected from the trailer;

FIG. 2 is a magnified perspective view illustrating one embodiment of attaching the pin and housing member of a connection unit together; and

FIG. 3 is a cross-sectional rear view illustrating one embodiment of attaching the pin and housing member of a connection unit together.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. In the following description, numerous specific details are provided. One skilled in the relevant art will recognize, however, that the subject matter of the present application may be practiced without one or more of the specific details, or with other methods, components, materials, and so forth. In other instances, well-known structures, materials, or operations are not shown or described in detail to avoid obscuring aspects of the disclosure.

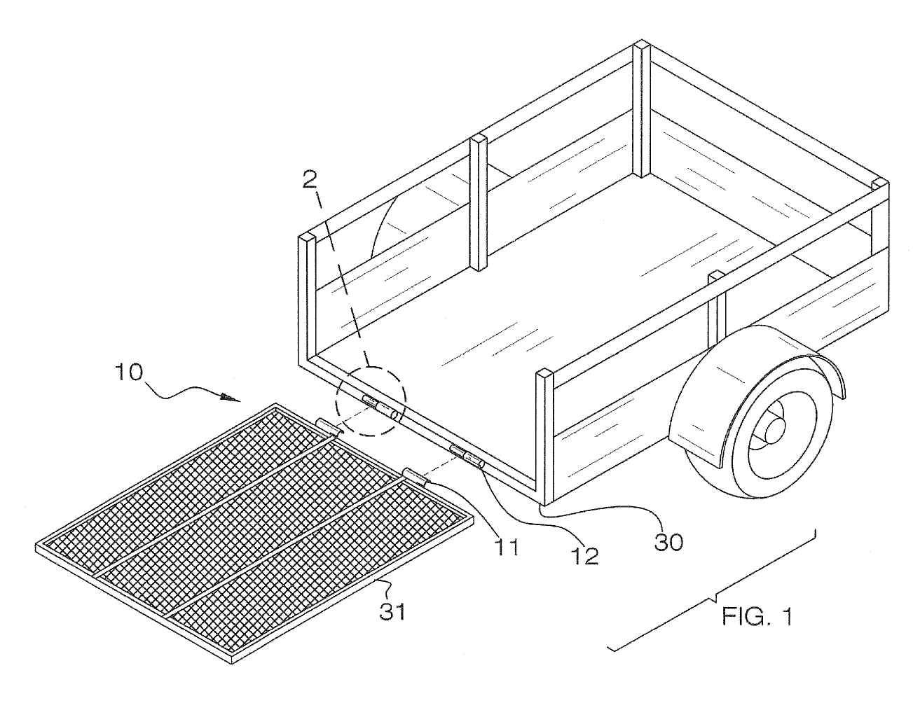

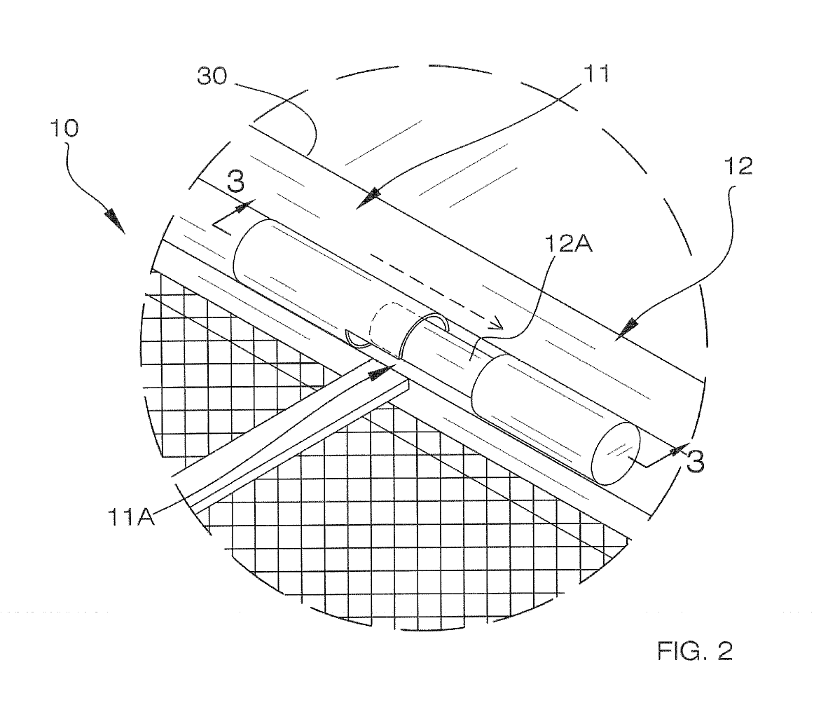

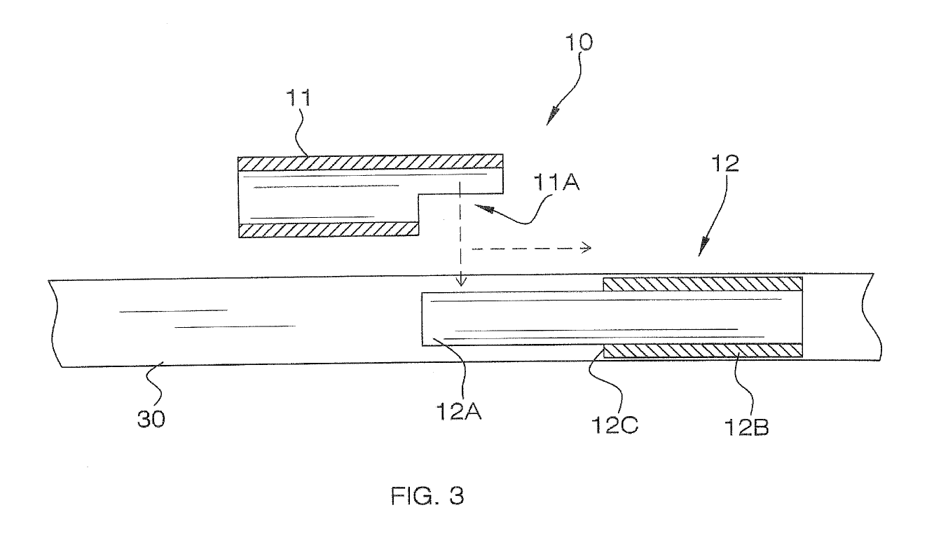

Detailed reference will now be made to one embodiment of the present disclosure, examples of which are illustrated in FIGS. 1-3. A trailer ramp connection assembly 10 includes a housing member 11 and a pin 12. The housing member 11 is composed of a cylindrical stock having a cutaway 11A about a first end of said housing member 11. The pin 12 is comprised of a first half 12A and a second half 12B. The diameter of the first half 12A is less than the diameter of the second half 12B and thus forms a shoulder 12C. The diameter of the first half 12A is slightly smaller than the inside diameter of the first end of the housing member 11, and thus enables the housing member 11 to slide over and upon the pin 12. The housing member 11 slides along said pin 12 until the housing member 11 engages the shoulder 12C of said pin 12.

The housing member 11 and the pin 12 are made of a material comprising a metal, a carbon fiber composite, a wood, or a durable plastic, among others. The connection assembly 10, as depicted, involves a plurality of housing members 11 and corresponding pins 12, jointly referred to as a connection unit. In certain embodiments it is anticipated that multiple connection units can be used, thus the orientation of the cutaways 11A of the housing members 11 are aligned and consistently oriented in the same direction. Without consistency in orientation of said cutaways 11A the connection assembly 10 would be inoperable. Said cutaways 11A, according to one embodiment, are oriented along a bottom when the ramp 31 is horizontal.

The connection assembly 10 simply enables a ramp 31 or a gate (not depicted) to be attached to or removed from a trailer 30. An additional utility of the connection assembly 10 is to reduce the wind resistance of the trailer 30 that is attributed with having to transport the ramp 31 or gate in the vertical position. Removal of the gate ramp can significantly improve fuel efficiency of the vehicle towing said trailer 30.

The housing members 11 are depicted as being connected to the ramp 31 and the pins 12 to the trailer 30. However, it shall be noted that the housing members 11 may be affixed to the trailer 30 and the pins 12 to the ramp 31, but in such embodiments the cutaways 11A must be oriented on top such that the pins 12 would be placed on said cutaway 11A during assembly. Furthermore, it is noted that the housing members 11 and the pins 12 attach to the ramp 31 and the trailer 30 via fastening means, such as welding, molding, or adhering, among others.

With respect to the above description, it is to be realized that the optimum dimensional relationships for the various components of the connection assembly 10 include variations in size, materials, shape, form, function and the manner of operation, assembly and use. It is also anticipated that those skilled in the art will readily recognize numerous adaptations and modifications which can be made to the various embodiments of the present connection assembly 10 which will result in an improved system and method, yet all of which fall within the scope of the present disclosure.

The subject matter of the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method for connecting a trailer ramp to a trailer, the method comprising:
providing a trailer, wherein either a first and a second housing member or a first and a second pin are affixed to the trailer;
providing a ramp, wherein the other of the first and the second housing member or the first and the second pin are affixed to the ramp;
wherein each of the housing members comprises a hollowed-out cylindrical stock having a tubular portion and a semi-tubular portion, the semi-tubular portion having a cutaway that forms a substantially half-tubular surface;
a single person initially engaging the semi-tubular portion of the first housing member with the first pin;
the single person initially engaging the semi-tubular portion of the second housing member with the second pin; and
the single person sliding the ramp along the length of the pins to fully engage the first and second pins into the tubular portions of the first and second housing members.

2. The method of claim 1, wherein each of the pins comprises a cylindrical stock that has a narrow portion and a wide portion, the narrow portion having a diameter less than the inside diameter of the housing members and the wide portion having a diameter greater than the inside diameter of the housing members.

3. The method of claim 2, wherein the two housing members are affixed to the ramp and the two pins are affixed to the trailer.

4. The method of claim 3, wherein initially engaging the semi-tubular portion of the first housing member with the first pin comprises lifting a first side of the ramp above the height of the first pin and resting the semi-tubular portion of the first housing member on top of the narrow portion of the first pin.

5. The method of claim 3, wherein initially engaging the semi-tubular portion of the second housing member with the second pin comprises lifting a second side of the ramp above the height of the second pin and resting the semi-tubular portion of the second housing member on top of the narrow portion of the second pin.

6. A method for disconnecting a trailer ramp from a trailer, the method comprising:
providing a trailer, wherein either a first and a second housing member or a first and a second pin are affixed to the trailer;
providing a ramp, wherein the other of the first and the second housing member or the first and the second pin are affixed to the ramp and the ramp and the trailer are connected together;
wherein each of the housing members comprises a hollowed-out cylindrical stock having a tubular portion and a semi-tubular portion, the semi-tubular portion having a cutaway that forms a substantially half-tubular surface;
a single person sliding the ramp along the length of the pins to remove the first and second pins from the tubular portion of the first and second housing members;
the single person disengaging the semi-tubular portion of the first housing member from the first pin; and
the single person disengaging the semi-tubular portion of the second housing member from the second pin.

7. The method of claim 6, wherein each of the pins comprises a cylindrical stock that has a narrow portion and a wide portion, the narrow portion having a diameter less than the inside diameter of the housing members and the wide portion having a diameter greater than the inside diameter of the housing members.

8. The method of claim 7, wherein the two housing members are affixed to the ramp and the two pins are affixed to the trailer.

9. The method of claim 8, wherein disengaging the semi-tubular portion of the first housing member from the first pin comprises lifting a first side of the ramp above the height of the first pin and resting the first side of the ramp on the ground.

10. The method of claim 8, wherein disengaging the semi-tubular portion of the second housing member from the second pin comprises lifting a second side of the ramp above the height of the second pin and resting the second side of the ramp on the ground

11. The method of claim 6, further comprising placing the disconnected ramp in the trailer for transport.
